(19) United States
(12) Patent Application Publication
(10) Pub. No.: US 2025/0360619 A1
(43) Pub. Date: Nov. 27, 2025

(54) POSITION CONTROL DEVICE

(71) Applicant: OKUMA Corporation, Niwa-gun (JP)

(72) Inventor: Fumiya SATO, Niwa-gun (JP)

(21) Appl. No.: 19/214,540

(22) Filed: May 21, 2025

(30) Foreign Application Priority Data
May 22, 2024 (JP) 2024-083372

(51) Int. Cl. B25J 9/16

(52) U.S. Cl. CPC B25J 9/1633; B25J 9/1664

(57) ABSTRACT

A position control device for controlling a position of a control target is configured to calculate a velocity command value and a torque command value based on a position command value and a position detection value; determine, based on the velocity command value calculated from the position command value, whether or not the control target is operating at a constant velocity in a very low velocity region in which the velocity of the control target is in a velocity range that is less than or equal to a predefined threshold value; and then add, in response to determining, based on an acceleration command value, that the control target is being in very low constant velocity operation, a friction compensation amount for compensating for friction generated in the very low constant velocity operation to at least one of the torque command value, the velocity command value, and the position command value.

### CROSS REFERENCE TO RELATED APPLICATION

The present invention claims priority under 35 U.S.C. § 119 to Japanese Patent Application No. 2024-083372 filed on May 22, 2024, which is incorporated herein by reference in its entirety including the specification, claims, drawings, and abstract.

### TECHNICAL FIELD

The present specification discloses a position control device for use in, for example, a machine tool.

### BACKGROUND

As an example of conventional position control devices for use in machine tools, FIG. 3 illustrates a block diagram corresponding to a position control device disclosed in Patent Document 1. The structure and the operation of a position control device 112 illustrated in FIG. 3 will be described below. A position command value Pos_ref is input to the position control device 112 from a host device (not illustrated).

The position command value Pos_ref is differentiated with respect to time by a differentiator 101 and a differentiator 104, and the respective outputs serve as a velocity command value V and an acceleration command value A. The acceleration command value A is amplified by a factor of an acceleration torque conversion constant K by an amplifier 105, and the result serves as an acceleration torque command value τaa for generating a corresponding acceleration in a target system 110. The velocity command value V and the acceleration torque command value τaa are respectively added to an output from a position controller 102 and an output from a velocity controller 108. This processing sequence constitutes a well-known feedforward process, which is directed toward an improved responsivity of a position detection value Pos to the position command value Pos_ref.

A subtractor 100 subtracts the position detection value Pos from the position command value Pos_ref to calculate a position deviation Pos_ref-Pos. It should be noted that the position detection value Pos is a position detection signal obtained by detecting the position of a control target of the target system 110 using, for example, a linear scale (not illustrated).

The position controller 102 proportionally amplifies the position deviation [Pos_ref-Pos] by a position loop gain. The output from this position controller 102 is added, at an adder 103, to the velocity command value V and a startup friction compensation value Vsfc, thus calculating a final velocity command value Vc. A subtractor 107 subtracts, from the final velocity command value Vc, a velocity detection value Vel obtained by detecting the velocity of the target system 110 (that is, the control target) using, for example, a linear scale (not illustrated) to calculate a velocity deviation [Vc−Vel]. The velocity detection value Vel is, for example, either a time derivative value of a rotational angular position of a position detector coupled to a servo motor inside the target system 110 or an output from a velocity detector coupled to the servo motor. The velocity controller 108 is a typical PI controller, which amplifies the velocity deviation [Vc−Vel] by a proportional gain of the velocity loop and an integral gain of the velocity deviation.

The output from the velocity controller 108 is added, at an adder 109, to the acceleration torque command value τaa, thus calculating a torque command value τc. The torque command value τc is input to the target system 110, bringing the target system 110 into operation.

An overview of the conventional position control device 112 illustrated in FIG. 3 will be described below. From immediately before to after a control target starts moving from a standstill state, in other words, upon startup, the frictional force may be discontinuous. The conventional position control device 112 includes a startup friction compensation calculation unit 111 for performing torque compensation upon the startup. In response to detecting, from the velocity command value V, that the target system 110 moves in different directions of movement with a stop interposed so that the direction of movement before the stop is different from that after the startup, the startup friction compensation calculation unit 111 generates a friction compensation value Vsfc upon the startup in a predetermined form in accordance with a startup motor generated torque detected from the torque command value τc and an amount of change in frictional torque immediately after the startup, thereby improving tracking characteristics during the startup.

### CITATION LIST

### Patent Literature

Patent Document 1: JP 3840429 B

The conventional position control has a problem in that, when the control target decelerates to a very low velocity and continues a constant velocity operation at the very low velocity in the same direction without stopping completely, the position tracking accuracy may deteriorate immediately after start of the very low constant velocity operation.

It is widely known that a guide mechanism such as, in particular, a sliding guide, in the target system 110 assumes a state of boundary lubrication, mixed lubrication, or hydrodynamic lubrication depending on the operation velocity. As the characteristics of the coefficient of friction that occurs in these states, characteristics represented by a Stribeck curve are widely known in which a large frictional force is observed in a low velocity region, subsequently turning into temporary decrease and then turning again into increase.

The following description specifically considers the operation of the target system 110 that starts decelerating from a velocity region of the hydrodynamic lubrication state and moves after it has decelerated to a very low velocity corresponding to the boundary lubrication region. Upon deceleration, the torque command value τc output from the position control device 112 is less than the driving torque required in the mixed lubrication region as, upon deceleration, the frictional force acts in the decelerating direction. If, in that state, an attempt is made to transition into a very low constant velocity operation in the boundary lubrication region, torque will be insufficient, as the required torque is larger than that in the hydrodynamic lubrication region. As a result, positional tracking is delayed.

FIG. 4 illustrates a temporal waveform of the above-described tracking delay. In the example of FIG. 4, the velocity command value V decreases to a low velocity region at time T1. From time T1 on, the velocity command value V that causes a constant velocity movement to continue in the same direction while maintaining the low velocity without stopping is input. In the example of FIG. 4, the above-described phenomenon causes tracking delay in position deviation Diff to occur immediately after time T1.

Patent Document 1 discloses a technique of performing compensation to reduce the tracking delay upon restart after a stop. However, as the target system 110 does not assume a zero velocity upon a transition to the very low velocity, no compensation is performed, resulting in failure to remove the above-described tracking delay.

### SUMMARY

According to an aspect of the present disclosure, there is provided a position control device for controlling a position of a control target. The position control device is configured to successively calculate a velocity command value and a torque command value based on a position command value and a position detection value; determine, based on a velocity and an acceleration of the control target that are calculated from the position command value, whether or not the control target is operating at a constant velocity in a very low velocity region in which the velocity of the control target is in a velocity range that is less than or equal to a predefined threshold value, that is, whether or not the control target is currently in “very low constant velocity operation”; and add, in response to determining that the control target is in very low constant velocity operation, a friction compensation amount for compensating for friction generated in the very low constant velocity operation to at least one of the torque command value or the velocity command value or the position command value.

The position control device disclosed herein enables an effective reduction in tracking delay in a drive system in which tracking delay caused by friction occurs in a very low velocity region.

### BRIEF DESCRIPTION OF DRAWINGS

Embodiments of the present disclosure will be described based on the following figures, wherein:

FIG. 1 is a block diagram illustrating a structure of a position control device;

FIG. 2 illustrates a time response waveform of the position control device;

FIG. 3 is a block diagram illustrating a conventional position control device that has a friction compensation function that acts upon actuation of a feed shaft; and

FIG. 4 illustrates a time response waveform according to a conventional technique.

### DESCRIPTION OF EMBODIMENTS

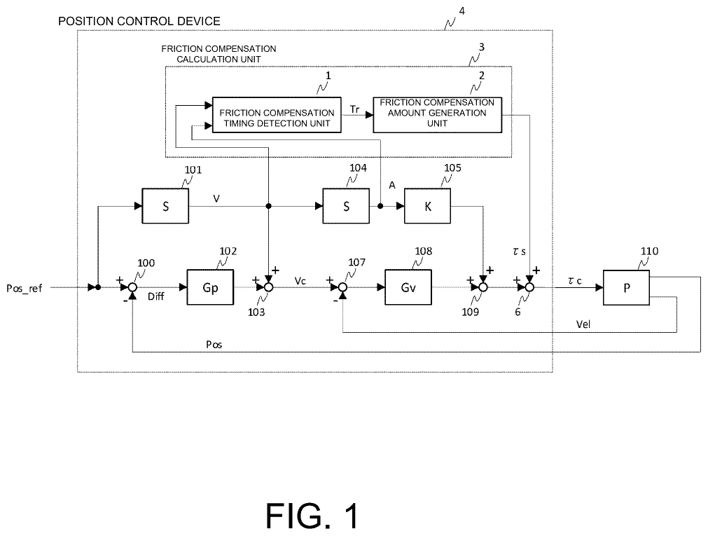

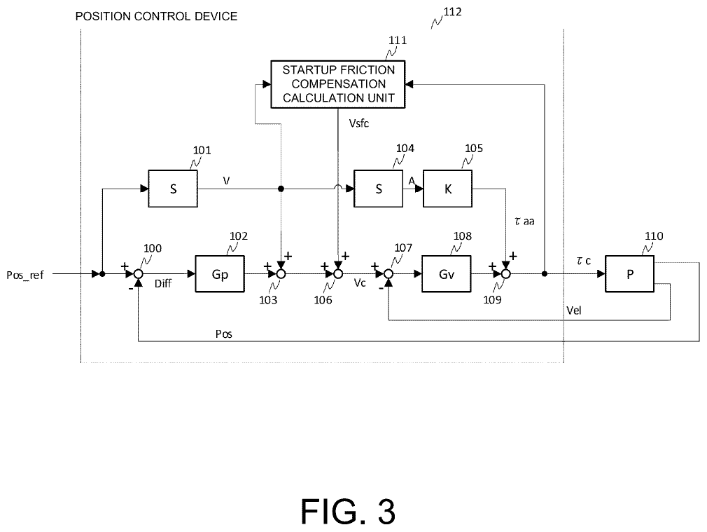

By referring to the accompanying drawings, a structure of a position control device will be described below. FIG. 1 is a block diagram illustrating an example structure of a position control device. The same components as those in FIG. 3 described above are referred to by the same names and denoted by the same reference numerals, and description of those components is not repeated here. The target system 110 is the control target that is to be controlled by the position control device.

A friction compensation calculation unit 3 will be described below. A friction compensation timing detection unit 1 and a friction compensation amount generation unit 2 calculate a friction compensation amount τs for compensating for tracking delay caused by friction. The friction compensation amount τs is added, at an adder 6, to the output from the adder 109, thus calculating the torque command value τc.

The friction compensation timing detection unit 1 determines whether or not the target system 110 is currently in very low constant velocity operation. Specifically, the friction compensation timing detection unit 1 determines that the target system 110 is in the very low velocity region when the absolute value of the velocity command value Vis less than or equal to a preset velocity threshold value Vth and greater than zero, and determines that the target system 110 is not in the very low velocity region when the absolute value of the velocity command value V is greater than the preset velocity threshold value Vth. The friction compensation timing detection unit 1 holds the result of this determination. The velocity threshold value Vth that defines the very low velocity region may be set in accordance with, for example, characteristics of the target system 110 (that is, the control target). For example, a velocity at which the guide mechanism of the control target transitions from the mixed lubrication state to the boundary lubrication state may be set as the velocity threshold value Vth. Alternatively, the velocity threshold value Vth may be a velocity at which the guide mechanism of the control target has the smallest coefficient of friction.

The friction compensation timing detection unit 1 determines that the target system 110 is in the very low constant velocity operation at the point in time when a preset duration of time or longer has elapsed in a state in which the velocity of the target system 110 is in the very low velocity region and the acceleration command value A is zero. The friction compensation timing detection unit 1 outputs a friction compensation trigger signal Tr. By virtue of being in the very low constant velocity operation, the friction compensation trigger signal Tr has the same sign as that of the velocity command value V and has an absolute value of 1. In contrast, in response to not being in the very low constant velocity operation, the friction compensation trigger signal Tr assumes zero. To determine whether or not the acceleration command value A is zero, the determination may be made when the acceleration command value A is exactly zero, or alternatively it should be understood that it can also be determined that the acceleration command value A is zero when the acceleration command value A is approximately zero, that is, for example, when the absolute value of the acceleration command value A is less than or equal to a predetermined value. It should be noted that, as movement in a reversed direction does not occur in a state in which the velocity of the target system 110 is in the very low velocity region and the acceleration command value A is zero, the function achieved by the present disclosure is independent of the compensation function for compensating for tracking delay when the direction of movement is reversed.

Assuming that the point in time at which it is detected that the value of the friction compensation trigger signal Tr has changed from zero to 1 or −1 is time t=0, the friction compensation amount generation unit 2 outputs the friction compensation amount τs according to Formula (1):

τs(t)=Tr×τca×exp(−t÷Td) (1)

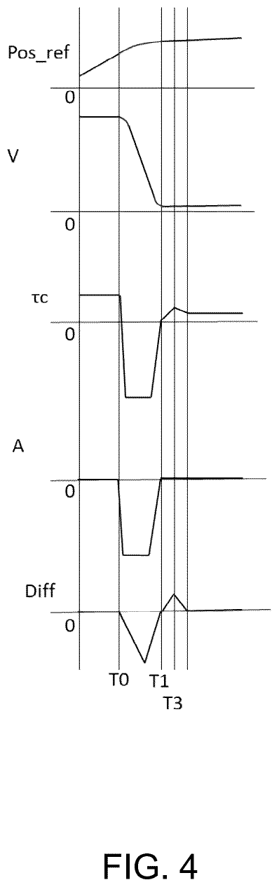

In Formula (1), the compensation amount amplitude τca and the compensation time constant Td are both predefined coefficients. For example, the compensation amount amplitude τca may be determined beforehand by experiment or simulation. The torque command value τc at the point in time when the position deviation Diff turns from an upward trend into a downward trend after the very low constant velocity operation is started with, for example, the friction compensation amount τs=0 (that is, at time T3 in FIG. 4) may be set as the compensation amount amplitude τca. Alternatively, the compensation amount amplitude τca may be determined by searching by changing the compensation amount amplitude τca so as to decrease the cumulative value of the position deviation Diff generated until the point in time when the position deviation Diff turns from an upward trend into a downward trend. Alternatively, based on Stribeck characteristics of the control target, a torque command value that matches with friction generated at a velocity that is equal to the velocity threshold value Vth (that is, a reference velocity below which the velocity is determined to be in the very low velocity region) may be identified, thus selecting this as the compensation amount amplitude τca.

The compensation time constant Td may also be determined beforehand by experiment or simulation. For example, for the compensation time constant Td, the very low constant velocity operation may be performed beforehand, and an elapsed time until the point in time when the position deviation Diff turns from an upward trend into a downward trend after the very low constant velocity operation starts, that is, T3−T1 in FIG. 4, may be set as the compensation time constant Td. Alternatively, the compensation time constant Td may be determined by searching by changing the compensation time constant Td so as to decrease the cumulative value of the position deviation Diff generated until the point in time when the position deviation Diff turns from an upward trend into a downward trend. In either case, according to Formula (1), the friction compensation amount τs assumes a large value immediately upon the start of the very low constant velocity operation and then declines sharply over time. This enables appropriate compensation for insufficient torque immediately after the very low constant velocity operation starts, thus effectively reducing tracking delay.

It should be noted that, while the friction compensation amount τs is output according to Formula (1) in the above-described example, the output form may be changed as desired so long as the friction compensation amount τs that fits characteristics of the target system 110 is obtained. For example, the friction compensation amount τs may be an impulse signal. Alternatively, the friction compensation amount τs may be stored beforehand in table or map form, one value for each elapsed time, rather than calculating the friction compensation amount τs using a formula, thus identifying the friction compensation amount τs from the table or the map.

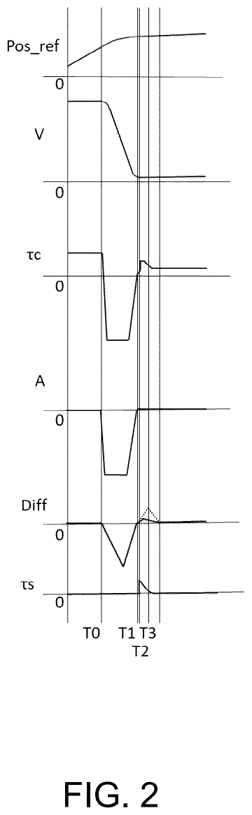

FIG. 2 illustrates time response for the above-described example. As illustrated in FIG. 2, the target system 110 first moves at a constant velocity, starts decelerating at time TO, and performs the very low constant velocity operation from time T1. In the above-described example, at time T1, it is detected that the velocity of the target system 110 is in the very low velocity region, and at the point in time when a duration of time during which the acceleration command value A is zero has elapsed, the point in time from which the compensation is to start, the friction compensation trigger signal Tr (not illustrated) becomes 1, causing the compensation to start. As such, at time T2, the friction compensation amount τs is added to the torque command value τc, resulting in a reduction in the position deviation Diff. In FIG. 2, Diff indicated by a broken line is the response waveform in the conventional technique illustrated in FIG. 4.

It should be understood that, in the above-described example, the structure illustrated in FIG. 1 does not define the order in which calculations are performed, but the order can be rearranged as desired by, for example, switching the order of calculations of the adder 6 and the adder 109 or integrating these into one calculation unit.

It should also be understood that the position control device is not limited to the feedback control system of FIG. 1 but may be, for example, a feedback control system operating in a state feedback manner, in which the velocity and the position are fed back to a single controller.

The structure of the position control device according to the above-described example can be used for controllers not only in machine tools but also in various types of industrial machines such as robots or others having a drive shaft which is driven by an electric motor and on which friction acts.

The position control device illustrated in FIG. 1 may be a computer that physically includes a processor and a memory and which performs multiple different operations. For example, the structure of the position control device may be implemented by executing various types of software stored in a storage device using a central processing unit (CPU) included in the position control device. Alternatively, the position control device may be implemented by a structure mainly composed of hardware including a field-programmable gate array (FPGA). The target system 110 herein (that is, the control target) includes, for example, a motor, a driver actuatable by the motor, an inverter for applying electric power to the motor in accordance with the torque command value τc, and a position sensor for detecting the position of either or both of the motor and the driver.

Although, in the above-described example, the friction compensation amount τs output from the friction compensation amount generation unit 2 is added to the torque command value τc, an equivalent function may be provided by instead adding, for example, the integrated result of the friction compensation amount τs to the velocity command value V. Similarly, an equivalent function may be provided by adding the twice integrated result of the friction compensation amount τs to the position command value Pos_ref.

### REFERENCE SIGNS LIST

1 friction compensation timing detection unit
2 friction compensation amount generation unit
3 friction compensation calculation unit
4 position control device
100, 107 subtractor
101, 104 differentiator
102 position controller
105 amplifier
108 velocity controller
6, 103, 106, 109 adder
110 target system
111 startup friction compensation calculation unit
112 position control device

1. A position control device for controlling a position of a control target, the position control device being configured to:
successively calculate a velocity command value and a torque command value based on a position command value and a position detection value;
determine, based on a velocity and an acceleration of the control target that are calculated from the position command value, whether or not the control target is operating at a constant velocity in a very low velocity region in which the velocity of the control target is in a velocity range that is less than or equal to a predefined threshold value; and
add, in response to determining that the control target is being in very low constant velocity operation, a friction compensation amount for compensating for friction generated in the very low constant velocity operation to at least one of the torque command value, the velocity command value, and the position command value.

2. The position control device according to claim 1, wherein the friction compensation amount is a value with a sign, the value having an absolute value that declines from a predefined compensation amount amplitude over time, the sign being the same as that of the velocity command value.

3. The position control device according to claim 2, wherein the position control device is configured to calculate the friction compensation amount according to Formula (1):
τs(t)=Tr×τca×exp(−t÷Td) (1)
where Tr represents a constant that is 1 when the velocity command value is a positive value or −1 when the velocity command value is a negative value, τca represents the compensation amount amplitude, Td represents a compensation time constant, and t represents an elapsed time after the very low constant velocity operation starts.

4. The position control device according to claim 2, wherein the compensation amount amplitude is a value that is determined to be the torque command value that matches with friction generated at a velocity threshold value below which the velocity of the control target is determined to be in the very low velocity region, based on Stribeck characteristics of the control target.

5. The position control device according to claim 3, wherein the compensation amount amplitude and the compensation time constant are respectively the torque command value and an elapsed time that are obtained at a point in time when a position deviation turns from an upward trend into a downward trend after the very low constant velocity operation starts under a condition where the friction compensation amount is zero.

6. The position control device according to claim 3, wherein the compensation amount amplitude and the compensation time constant are values that are obtained by searching by changing the compensation amount amplitude and the compensation time constant so as to decrease a cumulative value of position deviations generated until a point in time when a position deviation turns from an upward trend into a downward trend after the very low constant velocity operation starts.

7. A method of controlling a position of a control target, the method comprising:
successively calculating a velocity command value and a torque command value based on a position command value and a position detection value;
determining, based on a velocity and an acceleration of the control target that are calculated from the position command value, whether or not the control target is operating at a constant velocity in a very low velocity region in which the velocity of the control target is in a velocity range that is less than or equal to a predefined threshold value; and
adding, in response to determining that the control target is in very low constant velocity operation, a friction compensation amount for compensating for friction generated in the very low constant velocity operation to at least one of the torque command value, the velocity command value, and the position command value.
